(19) United States
(12) Patent Application Publication
(10) Pub. No.: US 2003/0039726 A1
(43) Pub. Date: Feb. 27, 2003

(54) Method of treating food products using irradiation and a modified atmoshpere

(75) Inventor: James T.C. Yuan, Naperville, IL (US)

Correspondence Address: Jasper W. Dockrey, Brinks Hofer Gilson & Lione, P.O. Box 10395, Chicago, IL, 60610, US

(73) Assignee: American Air Liquide Inc.

(21) Appl. No.: 09/939,451

(22) Filed: Aug. 24, 2001

(51) Int. Cl. A23L 3/00

(52) U.S. Cl. 426/234

(57) ABSTRACT

A method of treating a food product includes packaging the food product in a modified atmosphere, removing oxygen from the modified atmosphere and irradiating the food product, such that the oxidation of the food product is impeded for a predetermined period of time after irradiating the food product. The removal of oxygen can be accomplished by packaging the food product in a substantially oxygen-free modified atmosphere using a multi-layered packaging material in which the outer layer is an oxygen-impermeable layer and the inner layer is an oxygen-permeable layer. After completion of the irradiation process, the outer oxygen-impermeable layer can be removed, allowing oxygen to enter the package. In an alternative embodiment, an oxidant-reactive chemical substance is applied to the food product prior to irradiating the food product to scavenge oxidants, such as free radicals, from the package atmosphere.

### FIELD OF THE INVENTION

The present invention relates, generally, to methods for disinfecting and preserving packaged food commodities and, more particularly, to methods of preserving packaged food commodities using irradiation techniques.

### BACKGROUND OF THE INVENTION

As the demand for packaged food continues to grow, there is an increasing need for effective food preservation technology. Microbial outgrowth is a primary cause of food spoilage. The presence of pathogenic microorganisms on food products can potentially lead to food-borne outbreaks of disease and can cause significant economic loss to food processors. Microorganisms may gain access to food at virtually any stage of the food preparation process—from harvest of the raw materials through post-harvest storage, processing and distribution. The raw materials are susceptible to soil-borne microorganisms, which can include several different types of pathogenic microorganisms. Further, both food spoilage microorganisms and pathogenic microorganisms can arise through cross-contamination from food contact surfaces and the ambient atmosphere. The need to delay the onset of spoilage and to eliminate pathogens has led the food processing industry to continually seek more effective means of providing safe, packaged food products.

Food irradiation processes have been used in the food processing industry for many years. In particular, food irradiation processes using gamma rays (from nuclides Co-60 or Cs-137), x-rays (from machines operated at or below an energy level of 5 MeV) and electron beams (from machines operate at or below an energy level of 10 MeV) have been used to irradiate hamburger meat, poultry, fresh produce, spices and the like. Importantly, irradiation techniques have been shown to be very effective on bacteria, yeast and mold by causing lesions in the genetic material within the cells of microorganisms.

In a typical irradiation process for packaged food products, the food product is packaged in a gas atmosphere, which can be simply air, and sealed prior to exposing the food product to the irradiation source. Although the radiation is effective at killing both food spoilage and pathogenic microorganisms, the irradiation energy can interact with gas molecules within the package. When this occurs, activated molecules, such as activated oxygen, are generated within the package. In addition to attacking the microorganisms, the activated molecules also attack the food within the package. In the case of meat products, a high oxygen concentration within the package is necessary to give the meat a bright red color desired by consumers. Activated oxygen molecules created by irradiating the oxygen within the package, attacks both the microorganisms and the meat itself, giving the meat an undesirable color.

Simply eliminating oxygen from the gas atmosphere within a package containing a meat product is undesirable because oxygen is required to impart a bright red color to the meat. Further, opening the package after irradiation in order to inject oxygen creates a risk of microbial contamination after all disinfection processes are complete. Any post-irradiation contamination will increase the microbial load in the finished food product and result in a reduction of shelf-life. Further, the finished product can serve as a carrier of disease-causing pathogens that can lead to economic loss to producers and health risks to the consumer. Accordingly, improvements in the irradiation process are necessary to insure effective control of microbial growth, yet provide the necessary atmosphere within the food package.

### BRIEF SUMMARY

The present invention is for a method of treating a food product that includes packaging a food product in a modified atmosphere and irradiating the food product. The method further includes removing oxidants from the modified atmosphere, such that oxidation of the food product is impeded for a predetermined period of time after irradiating the food product.

In one aspect of the invention, oxygen is removed from the modified atmosphere by packaging the food product in a substantially oxygen-free modified atmosphere. A multi-layered packaging material is used to package the food product. The multi-layered packaging material includes an outer oxygen-impermeable layer and an inner oxygen-permeable layer. At some point after irradiating the food product, the outer oxygen impermeable layer can be removed. This allows oxygen to enter the package through the oxygen permeable layer.

In another aspect of the invention, oxygen is removed from the modified atmosphere by applying an oxygen-reactive chemical substance to the food product. The oxygen-reactive chemical substance scavenges oxygen from the modified atmosphere. Because of favorable reaction kinetics, the oxygen-reactive chemical substance preferentially reacts with oxygen in the modified atmosphere and with activated oxygen created during the irradiation process. The oxygen-reactive chemical substance can be one of several metal chelating agents or an antioxidant or the like.

### DETAILED DESCRIPTION OF PREFERRED EMBODIMENTS

The present invention is for a method for treating a food product that employs disinfection of the food product by the application of irradiation technology, while controlling potentially adverse effects of the irradiation on the modified gas atmosphere within a package. By either irradiating the food product in the absence of oxidants and subsequently introducing oxygen through an oxygen-permeable film, or by scavenging oxidants within the package before irradiation, the deleterious effects of oxidants and free radicals, such as activated oxygen, can be impeded. Thus, the inventive method takes full advantage of the benefits of food irradiation, yet minimizes the damage caused by oxidants on the food products. To further enhance the inventive treatment process, an oxidant-reactive chemical substance can be applied to the food products prior to packaging in a substantially oxidant-free atmosphere using a multi-layered packaging material. After irradiation, the outer oxygen impermeable layer can be removed, allowing oxygen to diffuse into the package.

In the present invention, the deleterious effects of oxidation are subdued by application of one or more of the disclosed process embodiments. Those skilled in the art will recognize that there are many aspects to the oxidation of a food product. For example, oxidation reactions can be characterized by reaction kinetics, such as the oxidation rate, the activation energy and the reaction extent and the like. As used herein, the term “impede” as applied to oxidation means to reduce the oxidation rate, to delay the onset of oxidation or to reduce the total amount of oxidation that occurs, or any combination of the foregoing. Accordingly, the inventive process can affect one aspect or any combination of aspects or all aspects of food oxidation kinetics.

In one embodiment of the invention, a food product, such as meat, poultry, fish, spices and the like, is placed in a food packaging material. The food packaging material can be a tray, such as a styrofoam tray, that can be sealed with a polymeric packaging material, or another type of food package, such as a plastic bag or pouch or the like. Where the package includes a tray, the tray is preferably sealed with a multi-layered packaging material that includes an oxygen-impermeable outer layer and an oxygen-permeable inner layer. In the case where the food package is simply a bag or pouch, the bag or pouch is preferably constructed of the multi-layer packaging material. Alternatively, the bag or pouch can be constructed of a non-permeable material and include a section constructed with the multi-layer packaging material.

In a preferred embodiment of the invention, the outer oxygen-impermeable layer is completely impermeable to oxygen or, alternatively, has an oxygen permeability of less than about 100 cubic centimeters per square meter per twenty-four hours (cc/m²/24 hr.). The oxygen transmission is preferably specified at a temperature of about 73° F. and a pressure of about one atmosphere. Correspondingly, the inner oxygen-permeable layer preferably has an oxygen permeability of more than about 100 cc/m²/24 hr.

In the inventive method, the food product is placed in the package and the package is charged with a substantially oxidant-free gas atmosphere. Preferably, the substantially oxidant-free modified atmosphere can include a gas, such as nitrogen, carbon dioxide, argon, krypton, xenon, neon and mixtures thereof. Those skilled in the art will appreciate that numerous modified atmosphere packaging (MAP) gas combinations are widely employed by the food packaging industry. Virtually any existing MAP technique can be used in the present invention, including gas flushing and evacuation techniques and the like.

Once the food product is placed in the package, and the package is charged with the modified atmosphere, the package is irradiated by any of the known irradiation techniques commonly used in the food processing industry. Accordingly, the irradiation can be gamma ray irradiation, x-ray irradiation, electron beam irradiation and the like.

Once the irradiation process is complete, the treated food product can be distributed to retail outlets, transported to a storage facility, or subjected to further processing. At some point after the irradiation process, the outer oxygen-impermeable layer can be removed from the package. Since the inner layer is oxygen-permeable, oxygen from the ambient air can diffuse into the package. In accordance with the invention, sufficient oxygen can diffuse into the package to provide any necessary oxygen-induced organoleptic property to the food product. Alternatively, if the particular food product does not need oxygen to restore its appearance or insure proper flavor, the outer oxygen-impermeable layer can remain in place. Accordingly, the irradiation of the food product effectively reduces the populations of bacteria, yeast and mold that are present on the food product, while enabling the food product to benefit from the presence of oxygen within the package, yet initially avoiding deleterious effects of activated oxygen and other oxidants on the food product.

In another embodiment of the invention, a food product, such as meat, poultry, fish, spices and the like, is packaged in a modified atmosphere can include oxygen. The packaged food product is subsequently subjected to irradiation as described above. Oxidants, such as oxygen in the package atmosphere, are substantially removed by complexing the oxidants with an oxidant-reactive chemical substance. Also, activated oxidant molecules created by the irradiation process are complexed. By removing oxidants, such as oxygen and activated oxygen and the like, from the package atmosphere, oxidation of the food product is impeded for a predetermined period of time after irradiating the food product.

The complexing of activated oxidants is accomplished by applying an oxidant-reactive chemical substance to the food product prior to packaging and irradiating the food product. Preferably, an oxygen-reactive chemical substance, such as is a metal chelating agent or an antioxidant is applied to a surface within the package or to the food product. The metal chelating agent can be a phosphate, ascorbic acid and the like. The antioxidant can be any of several commonly-used antioxidant chemicals, such as butylated hydroxyanisol and butylated hydroxytoluene and the like. The method of invention can be used with any of a number of widely-known, edible, oxidant scavenging agents. Accordingly, although specific materials are recited herein, it is within the scope of the present invention to use any known, edible, oxidant-reactive chemical agent commonly used in the food processing industry.

The oxidant-reactive chemical substance will continually remove oxidant, such as oxygen, and, preferentially, activated oxygen from the modified atmosphere within the package for an extended period of time. Those skilled in the art will appreciate that the amount of oxygen scavenged by the oxidant-reactive chemical substance will depend upon the amount of chemical applied and the particular technique used to apply the chemical substance.

In yet another embodiment of the invention, an oxidant-reactive chemical substance is applied to the food product, and the food product is packaged in a substantially oxygen-free modified atmosphere. Then, the packaged food product is irradiated by any of the irradiation techniques described above. Also, the oxidant-reactive chemical substance can be any of the substances described above or any other commonly-used oxidant-scavenging agents employed in the food processing industry.

The method of the instant embodiment can also include the application of a multi-layered package material for packaging the food product. In accordance with the earlier-described embodiment, the packaging material is preferably a multi-layered film that includes an inner oxygen-permeable layer and an outer oxygen-impermeable layer. By combining an oxidant-free atmosphere and multi-layered packaging material with an oxidant-reactive chemical substance, the formation of activated oxidant species is effectively prevented and the concentration level of oxygen subsequently diffusing into the package can be controlled.

Thus, it is apparent that there has been described, in accordance with the invention, a method of treating a product that fully provides the advantages set forth above. Although the invention has been described with respect to specific, preferred embodiments thereof, those skilled in the art will appreciate that various modifications can be made without departing from the spirit and scope of the invention. For example, the inventive process can be integrated with other food packaging processes, such as chemical disinfection and preservation treatments and the like. Accordingly, all such variations and modifications are within the scope of the appended claims and equivalents thereto.

1. A method of treating an irradiated food product comprising packaging a food product in a modified atmosphere and removing oxidants from the modified atmosphere, such that oxidation of the food product is impeded for a predetermined period of time after packaging the food product.

2. The method of claim 1, wherein packaging a food product comprises packaging the food product in a multi-layer film,wherein the multi-layer film includes an inner oxygen-permeable layer and an outer oxygen-impermeable layer, and wherein removing oxidants from the modified atmosphere comprises packaging the food product using a substantially oxidant-free modified atmosphere.

3. The method of claim 2 further comprising removing the outer oxygen-impermeable layer after irradiating the food product.

4. The method of claim 1, wherein packaging the food product further comprises applying an oxidant-reactive chemical substance to the food product.

5. The method of claim 4, wherein applying an oxidant-reactive chemical substance comprises applying a chemical selected from the group consisting of a metal chelating agent and an antioxidant.

6. The method of claim 5, wherein applying a metal chelating agent comprises applying a chelating agent selected from the group consisting of a phosphate and ascorbic acid.

7. The method of claim 5, wherein applying an antioxidant comprises applying an antioxidant selected from the group consisting of butylated hydroxyanisole and butylated hydroxytoluene.

8. A method of treating a food product comprising:
packaging a food product in a substantially oxidant-free modified atmosphere using a multi-layer film, wherein the multi-layer film includes an inner oxygen-permeable layer and an outer oxygen-impermeable layer; and
irradiating the food product.

9. The method of claim 8 further comprising removing the outer oxygen-impermeable layer after irradiating the food product.

10. The method of claim 8, wherein the inner oxygen-permeable layer comprises a film having an oxygen transmission rate of at least about 100 cc/m²/24 hours.

11. The method of claim 8, wherein the outer oxygen-impermeable layer comprises an oxygen transmission rate of no more than about 100 cc/m²/24 hours.

12. The method of claim 8, wherein the substantially oxidant-free modified atmosphere comprises a gas selected from the group consisting of nitrogen, carbon dioxide, argon, krypton, xenon, neon and mixtures thereof.

13. The method of claim 8, wherein irradiating the food product comprises subjecting the food product to radiation selected from the group consisting of gamma ray, x-ray and electron beam.

14. The method of claim 13, wherein irradiating the food product comprises substantially reducing populations of microorganisms selected from the group consisting of bacteria, yeast and molds that are present on the food product.

15. The method of claim 8, wherein packaging the food product comprises placing the food product in a tray and sealing the substantially oxidant-free modified atmosphere within the tray using the multi-layer film.

16. The process of claim 8, wherein the food product comprises a food selected from the group consisting of meat, poultry, fish, fresh produce and spices.

17. A method of treating a food product comprising:
packaging a food product in a modified atmosphere; and
complexing oxidants and irradiating the food product, such that oxidation of the food product is impeded for a predetermined period of time after irradiating the food product.

18. The method of claim 17, wherein complexing oxidants comprises applying an oxidant-reactive chemical substance to the food product.

19. The method of claim 18, wherein applying an oxidant-reactive chemical substance comprises applying a chemical selected from the group consisting of a metal chelating agent and an antioxidant.

20. The method of claim 19, wherein applying a metal chelating agent comprises applying a chelating agent selected from the group consisting of a phosphate and ascorbic acid.

21. The method of claim 19, wherein applying an antioxidant comprises applying an antioxidant selected from the group consisting of butylated hydroxyanisole and butylated hydroxytoluene.

22. A method of treating a food product comprising:
applying an oxidant-reactive chemical substance to the food product;
packaging a food product in a substantially oxidant-free modified atmosphere; and
irradiating the food product.

23. The method of claim 22, wherein packaging the food product comprises packaging the food product in a multi-layer film, wherein the multi-layer film includes an inner oxygen-permeable layer and an outer oxygen-impermeable layer.

24. The method of claim 23, wherein the inner oxygen-permeable layer comprises a film having an oxygen transmission rate of at least about 100 cc/m²/24 hours.

25. The method of claim 23, wherein the outer oxygen-impermeable layer comprises an oxygen transmission rate of no more than about 100 cc/m²/24 hours.

26. The method of claim 23 further comprising removing the outer oxygen-impermeable layer after irradiating the food product.

27. The method of claim 22, wherein packaging the food product further comprises applying an oxidant-reactive chemical substance to the food product.

28. The method of claim 27, wherein applying an oxidant-reactive chemical substance comprises applying a chemical selected from the group consisting of a metal chelating agent and an antioxidant.

29. The method of claim 28, wherein applying a metal chelating agent comprises applying a chelating agent selected from the group consisting of a phosphate and ascorbic acid.

30. The method of claim 28, wherein applying an antioxidant comprises applying an antioxidant selected from the group consisting of butylated hydroxyanisole and butylated hydroxytoluene.

31. The method of claim 22, wherein the substantially oxidant-free modified atmosphere comprises a gas selected from the group consisting of nitrogen, carbon dioxide, argon, krypton, xenon, neon and mixtures thereof.

32. The method of claim 22, wherein packaging the food product comprises placing the food product in a tray and sealing the substantially oxidant-free modified atmosphere within the tray using a multi-layer film.
